(19) United States
(12) Patent Application Publication
(10) Pub. No.: US 2002/0017275 A1
(43) Pub. Date: Feb. 14, 2002

(54) Noise limiting air duct for the air intake system of an internal combustion engine

(76) Inventors: Matthias Alex, Heilbronn (DE); Helmut Spannbauer, Ludwigsburg (DE)

Correspondence Address: CROWELL & MORING LLP, INTELLECTUAL PROPERTY GROUP, P.O. BOX 14300, WASHINGTON, DC, 20044-4300, US

(21) Appl. No.: 09/875,291

(22) Filed: Jun. 7, 2001

Related U.S. Application Data
(63) Continuation of application No. PCT/EP99/06975, filed on Sep. 21, 1999.

(30) Foreign Application Priority Data
Dec. 8, 1998 (DE) 198 56 521.6

(51) Int. Cl. F02D 9/10; F02M 35/12

(52) U.S. Cl. 123/403; 123/184.21

(57) ABSTRACT

An air duct for inclusion in the air intake tract of an internal combustion engine in which flow obstacles, especially wire-shaped flow obstacles, are arranged in the vicinity of the duct wall (21) in order to improve the acoustic characteristics of the duct. The flow obstacle may, for example, be wire strands (29). The flow obstacles are capable of decreasing the acoustic noise emitted by the air duct while maintaining a low flow resistance since the center part of the duct cross-section remains unaffected by the flow obstacles. The flow obstacles may advantageously be arranged in the discharge area of flap valves since so that the valves are prevented from whistling when they are only open a small way. In order to simplify the manufacturing and assembly costs, the flow obstacles may be disposed in the area of a flanged joint in the air intake duct.

### CROSS REFERENCE TO RELATED APPLICATIONS

This application is a continuation of international application no. PCT/EP99/06975, filed Sep. 21, 1999, the entire disclosure of which is incorporated herein by reference.

### FIELD OF THE INVENTION

The invention relates to an air duct suitable particularly for use in the intake system of an internal combustion engine, which has a device for smoothing the flow in the duct cross-section.

### BACKGROUND OF THE INVENTION

Devices of this type are known, for example, from EP 863 303 and are primarily used to improve the acoustics of intake pipes. The functional principle of the device is based on the fact that flow turbulence can be smoothed to prevent burble along the pipe walls. This makes it possible, for instance, to reduce or prevent the whistling noise that occurs when throttle valves are opened in such a way that they leave only a narrow gap open relative to the pipe wall. The devices consist, for example, of pipe inserts that extend into the interior of the intake pipe.

The acoustic advantage of the pipe inserts, however, is gained at the disadvantage of increased flow resistance, which results in power losses of the engine. These power losses contribute to an undesirable increase in the fuel consumption of the internal combustion engine. Furthermore, the pipe inserts must be mounted in the interior of the pipe, a location that is difficult to access, which involves additional production and assembly costs. Even if produced by casting, the complex shape involves undesirable additional costs in order to realize the acoustic feature.

### SUMMARY OF THE INVENTION

It is an object of the invention to provide a device for acoustic optimization, particularly of intake pipes, in which the flow losses are minimized.

A further object of the invention is to provide a device for acoustic optimization which can be produced and assembled at reasonable cost.

These and other objects are achieved in accordance with the present invention by providing an air duct for the intake system of an internal combustion engine, wherein flow obstacles are provided in the duct cross section to smooth the air flow, the cross-sectional area provided with the flow obstacles being smaller than the duct cross section, and the flow obstacles protruding from an air duct wall in the area of a duct joint into the interior of the duct cross section, the flow obstacles being are molded into or onto a gasket which is inserted into the duct joint.

The air duct according to the invention, which may be installed particularly in the intake system of an internal combustion engine, has flow obstacles in the duct cross-section to smooth the flow. These flow obstacles are not distributed over the entire duct cross section, however, but are merely mounted adjacent the pipe walls. It has been found that particularly for the acoustic optimization of intake pipes, only the flow along the pipe wall area needs to be smoothed. Introducing, for instance, a wire mesh extending over the entire duct cross section constitutes an unnecessary additional flow obstacle with respect to the flow occurring through the center of the pipe cross section.

If the flow obstacles are mounted in the area of a pipe joint, the production costs can be kept within reasonable limits. The component forming the flow obstacle may, for instance, be simply inserted into a recess, which is integrated in the mold that is used to produce the pipe sections. Another possibility is to fix the component in the flange area between two pipe sections during assembly.

The flow obstacles may be added along the entire circumference of the pipe wall of a certain cross section or only to parts thereof. For instance, if burbling is to be reduced along the inside of a pipe elbow, it is sufficient to add flow obstacles in the corresponding wall portion.

In accordance with one particular embodiment of the invention, the flow obstacles consist of a strand-like material, e.g., wire. Wire is available as an inexpensive semi-finished product and is easy to process. It can advantageously be integrally molded into the wall of the air duct. Other materials are also feasible, however, e.g., porous materials. It is also possible to provide ribs in the pipe mold, which point radially inwardly into the pipe interior. This is feasible particularly for plastic pipes. The use of wire-shaped semi-finished products or comparable materials has the additional advantage that they may be processed into a mesh, a braid, or similar geometries. Compared to solid flow obstacles, the geometries offer substantially less flow resistance with respect to the partial area of the flow cross section that they cover. Thus the flow passes through rather than around the flow obstacles, which has an additional flow smoothing effect in the area of the pipe wall behind the flow obstacles.

In accordance with another embodiment of the invention, the flow obstacles are integrally molded into or onto a gasket, which can be inserted, for example, in a flange joint of the unfiltered air duct. For instance, a wire mesh ring may be integrally molded into a gasket so that it protrudes into the area surrounded by the gasket. The flow obstacles may also be provided in a mold for the gasket, e.g., in the form of pins. The gasket may also be produced in a multi-component process, so that the material properties of the flow obstacles are independent of those of the gasket.

It is particularly advantageous to mount the flow obstacles in the downstream area of a throttle valve. It has been shown that a substantial acoustic improvement can be obtained with little pressure loss if the flow obstacles are arranged only in the sickle-shaped opening areas of the valve. This makes it possible to prevent the whistling noise in the throttle valve when the gap of the opening is small. This measure is of course also applicable in throttle valves that do not seal a round cross section. In this case the gaps are not sickle-shaped but have a different geometry.

In accordance with one advantageous embodiment of the invention, the flow obstacles are integrated directly in the throttle assembly. The throttle assembly can be cost-effectively produced as a standardized part in large series and can be used at different locations, e.g., in the intake system of an internal combustion engine.

These and other features of preferred embodiments of the invention, in addition to being set forth in the claims, are also disclosed in the specification and/or the drawings, and the individual features each may be implemented in embodiments of the invention either individually or in the form of subcombinations of two or more features and can be applied to other fields of use and may constitute advantageous, separately protectable constructions for which protection is also claimed.

### BRIEF DESCRIPTION OF THE DRAWINGS

The invention will be described in further detail hereinafter with reference to illustrative preferred embodiments shown in the accompanying drawings in which:

FIG. 1 is a cross section of a detail of an air duct with a throttle valve arranged directly behind the duct flange in which a gasket equipped with a wire mesh ring is used as a flow obstacle;

FIG. 2 shows detail X of FIG. 1 illustrating the structure of the gasket;

FIG. 3 is a top view of a throttle assembly in which wire strands are inserted as flow obstacles, and

FIGS. 4 and 5 illustrate alternative embodiments of gaskets with flow obstacles.

### DETAILED DESCRIPTION OF PREFERRED EMBODIMENTS

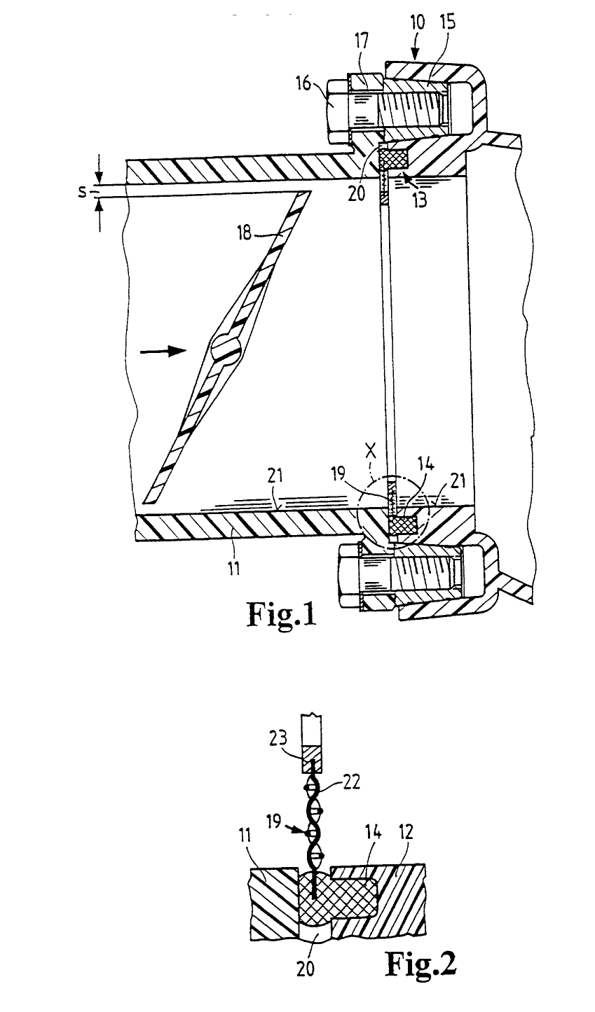

FIG. 1 shows a detail of an air duct with a flanged joint 10. The flange-connected pipes 11, 12 are made of synthetic resin material, i.e., plastic. A groove 13 for a gasket 14 is provided in the flange of pipe 12. The flange further has threaded couplings 15 to receive bolts 16. Corresponding holes 17, into which the bolts 16 are inserted, are provided in the flange of pipe 11. Pipe 11 contains an injection-molded throttle valve 18. An arrow indicates the flow direction.

In the position of the throttle valve shown, a gap s is formed between the edge of the throttle valve and the pipe wall. In the turbulence area of the outflow-side of the gap there is a wire mesh ring 19, which is integrally molded into the gasket 14 installed between pipes 11 and 12. Between the end faces of pipes 11 and 12, in the area of the flanged joint 10, there is an annular gap 20 in a wall 21 of the pipe. This gap creates the clearance necessary for wire mesh ring 19 attached to gasket 14.

The structure of gasket 14 in its mounted state is shown in FIG. 2. An annular gap 20 may be seen between the end faces of pipes 11 and 12. The dimensions of the annular gap are such that they cause gasket 14 to be deformed. The outer edge of the wire mesh ring 19 is integrally molded into the gasket. To prevent the ends of mesh wires 22 from fraying, an annular collar 23 is arranged along the inner edge of the wire mesh ring, which encloses the wire ends.

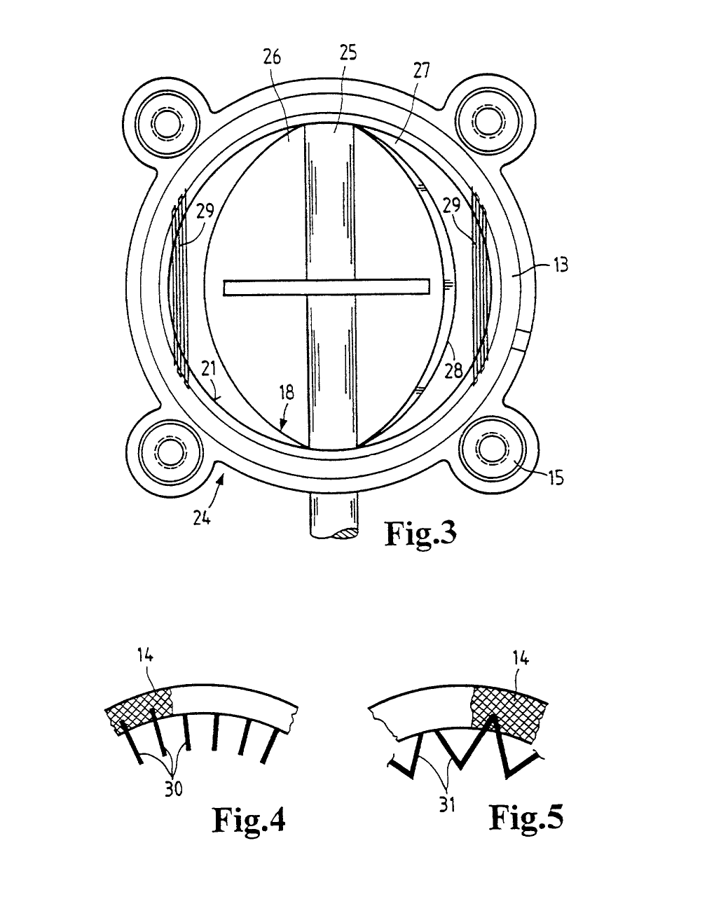

FIG. 3 shows a throttle assembly 24. The structure of the flange to be mounted to a pipe end (not shown) corresponds to that of pipe 12 shown in FIG. 1. Shown among other things are threaded coupling 15 and groove 13. The injection molded throttle valve 18 has a shaft 25 to which valve blades 26 are mounted. For drive purposes, shaft 25 is extended outside throttle assembly 24. The throttle valve is shown in its partly open state in which sickle-shaped valve passages 27 are formed. A valve edge 28 swings directly over wire strings 29, which are mounted as flow obstacles in the area of the valve passages 27. The wire strings are inserted in wall 21 during the production process of the throttle assembly. This may be accomplished, for instance, by clamping the wire strings into the injection mold and then integrally molding them into the wall. Another option is to heat the wire strings and then to melt them into the finished throttle assembly.

FIGS. 4 and 5 are variants of the flow obstacles integrated in gasket 14. Pins 30 may be integrally molded into the gasket. Stranded structures may also be formed in the ring mold so that they are molded onto the ring's inner surface. As shown in FIG. 5, it is also possible to mold a zigzag-shaped bent wire 31 into gasket 14.

The foregoing description and examples have been set forth merely to illustrate the invention and are not intended to be limiting. Since modifications of the disclosed embodiments incorporating the spirit and substance of the invention may occur to persons skilled in the art, the invention should be construed broadly to include all variations falling within the scope of the appended claims and equivalents thereof.

What is claimed is:

1. An air duct for the intake system of an internal combustion engine, wherein flow obstacles are provided in the duct cross section to smooth the air flow, the cross-sectional area provided with the flow obstacles being smaller than the duct cross section, and the flow obstacles protruding from an air duct wall in the area of a duct joint into the interior of the duct cross section, the flow obstacles being are molded into or onto a gasket which is inserted into the duct joint.

2. An air duct according to claim 1, wherein the flow obstacles are made of a stranded material.

3. An air duct according to claim 2, wherein said stranded material is wire.

4. An air duct according to claim 1, wherein said flow obstacles are provided behind a throttle valve in a flow area affected by said valve.

5. An air duct according to claim 4, wherein the flow obstacles are arranged in the area behind a gap which is formed by throttle valve when the valve is partially open.
